(19) United States
(12) Patent Application Publication
(10) Pub. No.: US 2014/0362589 A1
(43) Pub. Date: Dec. 11, 2014

(54) LENS

(71) Applicants: FOXCONN TECHNOLOGY CO., LTD., New Taipei (TW); CHAMP TECH OPTICAL (FOSHAN) CORPORATION, Foshan (CN)

(72) Inventors: CHIN-CHUNG CHEN, Tu-Cheng (TW); SHAN-YUE WANG, Foshan (CN)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 13/966,261

(22) Filed: Aug. 13, 2013

(30) Foreign Application Priority Data
Jun. 11, 2013 (CN) 2013102302336

(51) Int. Cl. F21V 5/04

(52) U.S. Cl. CPC F21V 5/045
USPC 362/335

(57) ABSTRACT

A lens includes a base and a protrusion formed on the base. The base defines a light incident face in a bottom face thereof. The protrusion forms a light emerging face at an outside face thereof. The light emerging face includes a freeform face, a first side face, a second side face, a third side face and a fourth side face. The freeform face, the first side face and the second side face diverge light along a first direction, and the freeform face, the third side face and the fourth side face converge light along a second direction. Thus, a rectangular light pattern is obtained.

### BACKGROUND

1. Technical Field

The disclosure generally relates to a lens, and more particularly, to a lens used with an LED (light emitting diode).

2. Description of Related Art

LEDs, available since the early 1960's and because of their high light-emitting efficiency, have been increasingly used in a variety of occasions, such as residential, traffic, commercial, and industrial occasions. Conventionally, light directly output from the LED is highly pointed and thus forms a small circular light spot on an object to be illuminated.

However, for road illumination, rectangular light patterns are generally required to achieve a wide illumination area. The small circular light spot of the LED cannot meet such road illumination requirement.

What is needed, therefore, is a lens which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a lens module incorporating a plurality of lens in accordance with an embodiment of the present disclosure.

FIG. 2 shows a single lens of the lens module of FIG. 1.

FIG. 3 is an inverted view of the lens of FIG. 2.

FIG. 4 shows a bottom of the lens of FIG. 2.

FIG. 5 shows a cross section of the lens of FIG. 4 taken along line V-V thereof.

FIG. 6 shows a cross section of the lens of FIG. 4 taken along line VI-VI thereof.

FIG. 7 shows a light distribution of the lens of FIG. 2.

### DETAILED DESCRIPTION

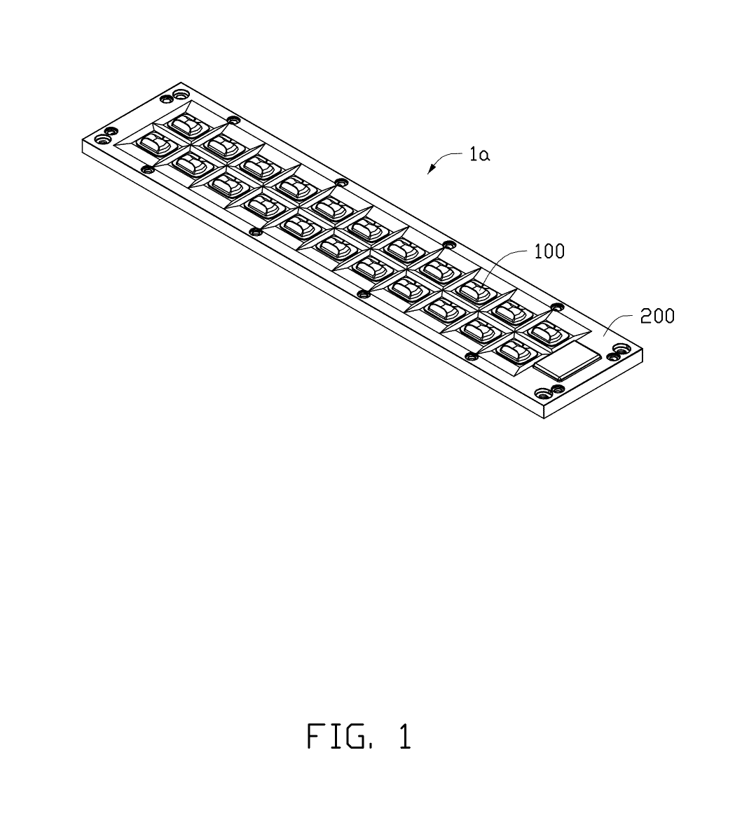

Referring to FIG. 1, a lens module la in accordance with an embodiment of the present disclosure is illustrated. The lens module 1a includes a plate 200 and a plurality of lenses 100 incorporated to the plate 200. In this embodiment, the plate 200 is transparent and rectangular. The plate 200 defines a plurality of holes to receive the lenses 100, respectively.

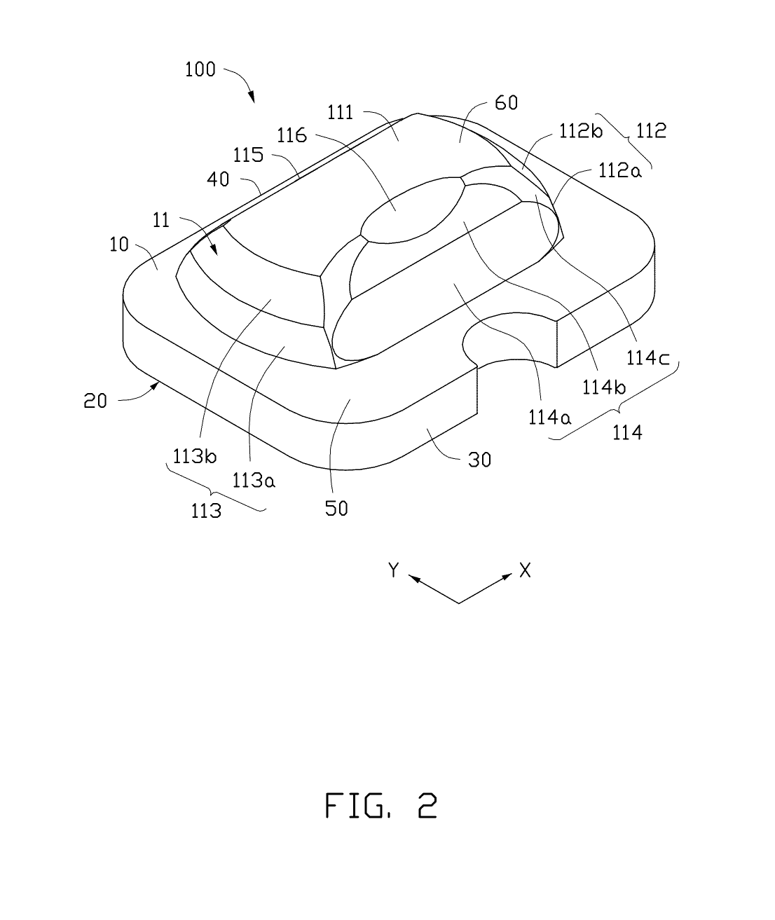

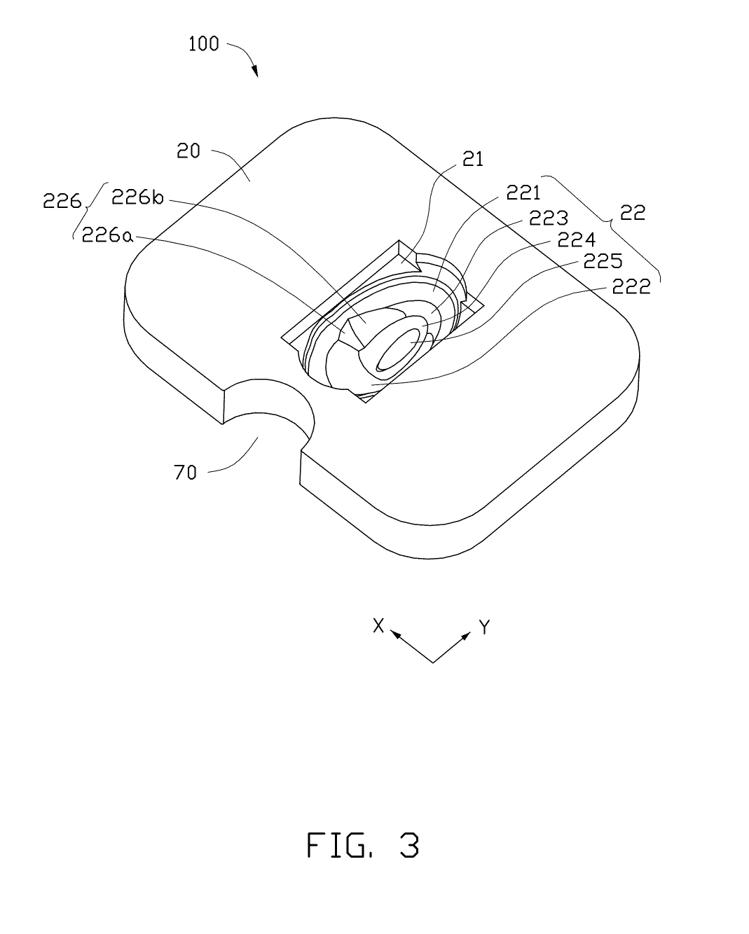

Also referring to FIGS. 2-3, each lens 100 is integrally made of a transparent material such as PC (polycarbonate) or PMMA (polymethyl methacrylate). Each lens 100 includes a base 50 and a protrusion 60 formed on the base 50. The base 50 includes a top face 10, a bottom face 20 opposite to the top face 10, and a first lateral face 30, a second lateral face 40, a third lateral face and a fourth lateral face interconnecting the top face 10 and the bottom face 20. The top face 10 of the base 50 is parallel to the bottom face 20 of the base 50. The first lateral face 30 and the second lateral face 40 are perpendicular to the top face 10. A cutout 70 is defined in the first lateral face 30 of the base 50. The cutout 70 is used to indicate a mounting direction of the lens 100. In this embodiment, the cutout 70 faces an inside of a road when the lens 100 is incorporated to a lamp placed beside the road.

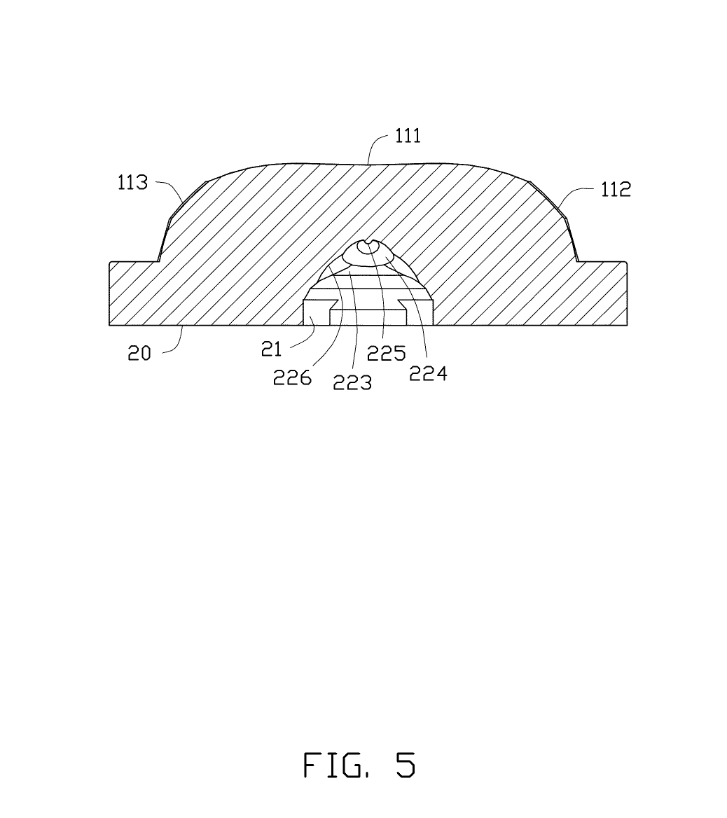

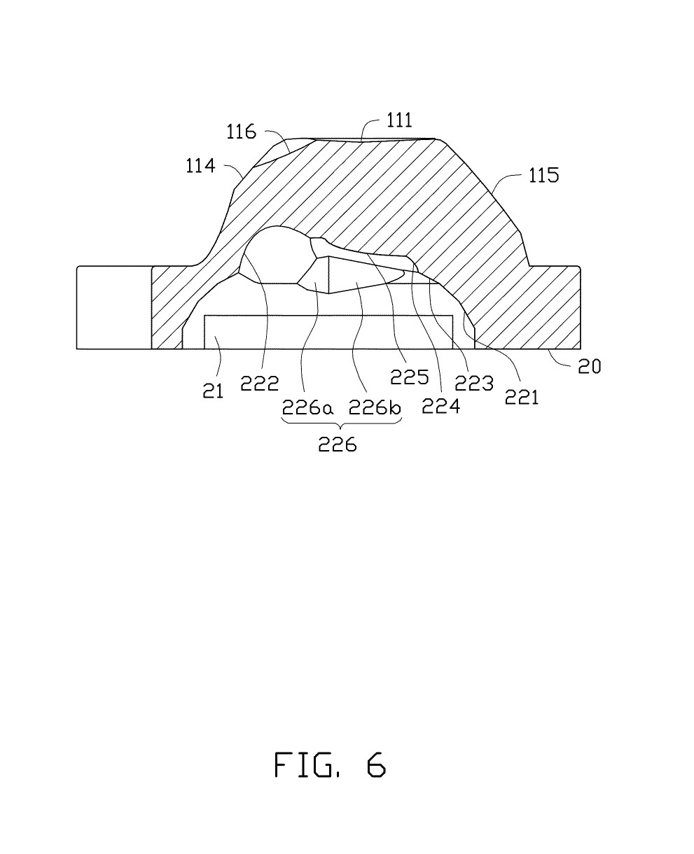

Also referring to FIGS. 5-6, the protrusion 60 is formed on the top face 10 of the base 50. The protrusion 60 is located adjacent to the second lateral face 40 of the base 50 and away from the first lateral face 30 of the base 50. The protrusion 60 forms a light emerging face 11 of the lens 10. The light emerging face 11 includes a freeform face 111, a first side face 112, a second side face 113, a third side face 114 and a fourth side face 115 connecting the freeform face 111 with the top face 10 of the base 50. The freeform face 111 is elongated along an X axis. The freeform face 111 is concave at a center thereof and convex at two opposite sides thereof along the X axis (see FIG. 5). The first side face 112 is convex, and includes a first curved face 112a and a second curved face 112b connecting the first curved face 112a. The first curved face 112a has a curvature different from that of the second curved face 112b. The second side face 113 is symmetrical with the first side face 112. The second side face 113 is also convex, and includes a first curved face 113a and a second curved face 113b having a curvature different from that of the first curved face 113a. In this embodiment, the curvatures of the first curved faces 112a, 113a are larger than that of the second curved faces 112b, 113b.

The third side face 114 includes a first concave face 114a, a flat face 114b and two connecting faces 114c. The first concave face 114a is an elliptical face having a long axis parallel to the X axis. The first concave face 114a has an area larger than that of the flat face 114b. The first concave face 114a is located between the first curved faces 112a, 113a of the first side face 112 and the second side face 113. The flat face 114b is inclined relative to the top face 10 and located above the first concave face 114a. The flat face 114b is located between the second curved faces 112b, 113b of the first side face 112 and the second side face 113. One connecting face 114c connects the top face 10, the first side face 112, the first concave face 114a, the flat face 114b and the freeform face 111. The other connecting face 114c connects the top face 10, the second side face 113, the first concave face 114a, the flat face 114b and the freeform face 111. A second concave face 116 is formed between the two connecting faces 114c. The second concave face 116 is an elliptical face which has a long axis parallel to the X axis. The second concave face 116 connects the freeform face 111, the two connecting faces 114c and the flat face 114b. The second concave face 116 has an area less than that of the first concave face 114a. The fourth side face 115 is convex and unsymmetrical with the third side face 114.

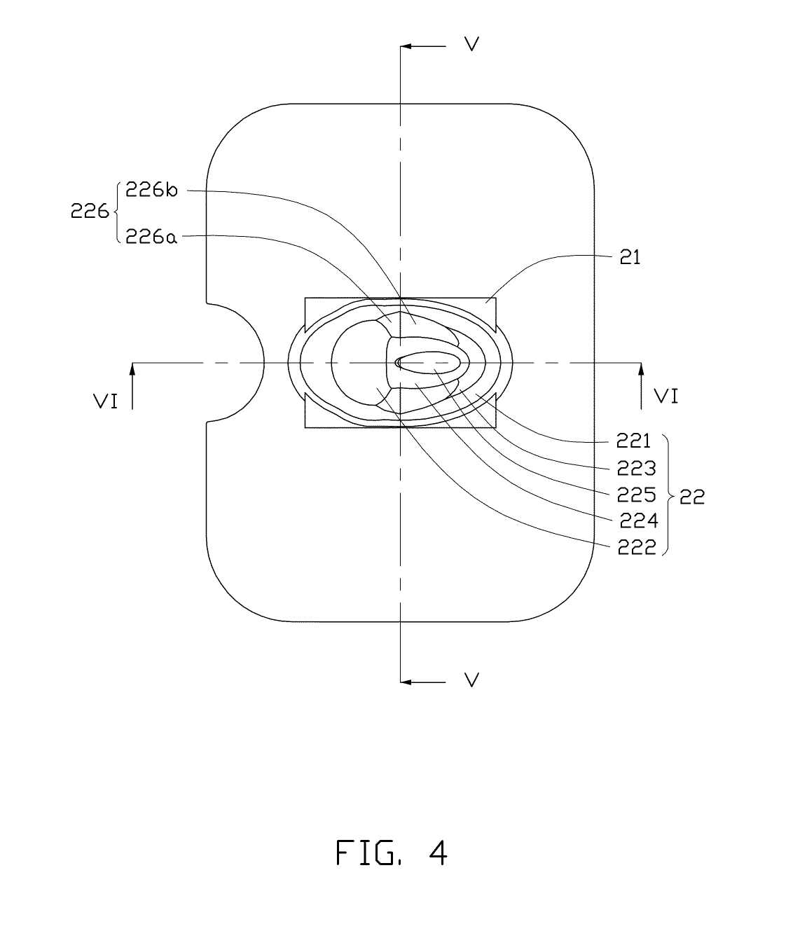

Also referring to FIG. 4, a cavity 21 is defined in the bottom face 10 of the base 50. The cavity 21 is rectangular and located adjacent to the cutout 70. A light incident face 22 is formed in the cavity 21. The light incident face 22 includes a first depressed face 221, a second depressed face 222, a third depressed face 223, a fourth depressed face 224 and a protruding face 225. The first depressed face 221, the second depressed face 222, the third depressed face 223, the fourth depressed face 224 and the protruding face 225 are all elliptical faces. Long axes of the first depressed face 221, the third depressed face 223, the fourth depressed face 224 and the protruding face 225 are parallel to a Y axis which is perpendicular to the X axis, and a long axis of the second depressed face 222 is parallel to the X axis. The first depressed face 221 is annular and surrounds the second depressed face 222, the third depressed face 223, the fourth depressed face 224 and the protruding face 225. The second depressed face 222 is located adjacent to the first lateral face 30 of the base 50, and the third depressed face 223 is located adjacent to the second lateral face 40 of the base 50. The second depressed face 222 is deeper than the third depressed face 223. In other words, a distance between the second depressed face 222 and the bottom face 20 of the base 50 is larger than that between the third depressed face 223 and the bottom face 20 of the base 50 (see FIG. 6). The fourth depressed face 224 is located between the second depressed face 222 and the third depressed face 223. The fourth depressed face 224 has a small end connecting the third depressed face 223, and a large end connecting the second depressed face 222. The fourth depressed face 224 is deviated from a center of the base 50, and located adjacent to the second lateral face 40 of the base 50 more than the first lateral face 30 of the base 50. The protruding face 225 is totally surrounded by the fourth depressed face 224. The protruding face 225 is convex in a direction away from the protrusion 60. The protruding face 225 is also deviated from the center of the base 50, and located adjacent to the second lateral face 40 of the base 50 more than the first lateral face 30 of the base 50.

Two ridges 226 are formed on the light incident face 22. The two ridges 226 are located at two opposite sides of the fourth depressed face 224 along the X axis. Each ridge 226 connects the first depressed face 221, the second depressed face 222, the third depressed face 223 and the fourth depressed face 224. Each ridge 226 includes a first arced face 226a and a second arced face 226b connecting the first arced face 226a. The first arced face 226a and the second arced face 226b are both elliptical faces. The first arced face 226a has an area less than that of the second arced face 226b. A long axis of the second arced face 226b is parallel to the Y axis, and a long axis of the first arced face 226a is parallel to the X axis.

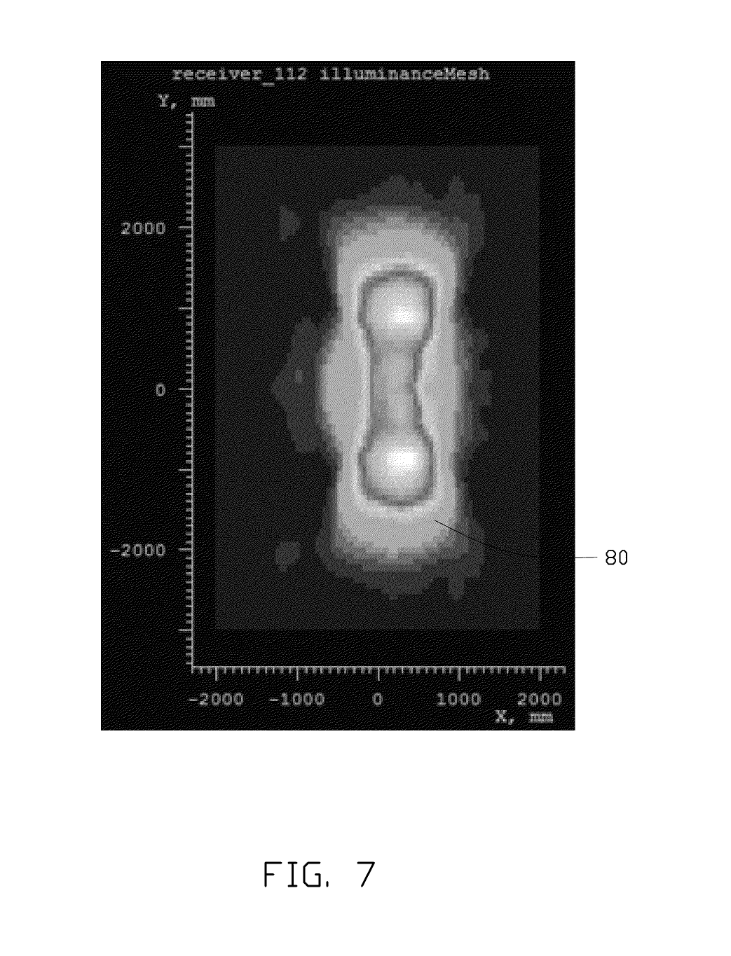

The light emerging face 11 of the lens 100 is substantially rectangular when viewed from a top of the lens 100. Thus, light emitted from the light emerging face 11 can have a substantially rectangular pattern 80 as shown in FIG. 7. Particularly, the freeform face 111 together with the first side face 112 and the second side face 113 can diverge the light along the X axis, and the freeform face 111 together with the third side face 114 and the fourth side face 115 can converge the light along the Y axis. Thus, the light pattern 80 is wide along the X axis and narrow along the Y axis. A ratio of a length to a wide of the light pattern 80 can achieve 3:1. Furthermore, the first concave face 114a, the flat face 114b and the second concave face 116 together with the light incident face 22 can refract the light to deflect towards a side of the lens 100, whereby the inside of the road can obtain much more light.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens for modulating light, comprising:
a base defining a light incident face; and
a protrusion formed on the base, the protrusion comprising a light emerging face opposite to the light incident face, the light emerging face comprising:
a freeform face which is longer along a first direction than along a second direction perpendicular to the first direction;
a first side face;
a second side face opposite to the first side face;
a third side face; and
a fourth side face opposite to the third side face;
wherein the freeform face together with the first side face and the second side face diverge the light along the first direction, and the freeform face together with the third side face and the fourth face converge the light along the second direction, thereby obtaining a substantially rectangular light pattern.

2. The lens of claim 1, wherein the first side face is symmetrical with the second side face.

3. The lens of claim 2, wherein the first side face is convex, and comprises a first curved face and a second curved face connecting the first curved face.

4. The lens of claim 3, wherein the first curved face has a curvature different from that of the second curved face.

5. The lens of claim 1, wherein the third side face and the fourth side face are unsymmetrical with each other.

6. The lens of claim 1, wherein the third side face comprises a first concave face and a flat face located between the first side face and the second side face.

7. The lens of claim 6, wherein the flat face connects the first concave face directly.

8. The lens of claim 6, wherein the third side face comprises two connecting faces, one of the two connecting faces directly connects the first side face, the first concave face, the flat face and the freeform face, and the other one of the two connecting faces directly connects the second side face, the first concave face, the flat face and the freeform face.

9. The lens of claim 8, wherein a second concave face is formed on the light emerging face, and the second concave face directly connects the two connecting faces, the freeform face and the flat face.

10. The lens of claim 9, wherein the second concave face has an area less than the area of the first concave face.

11. The lens of claim 9, wherein the second concave face is located above the flat face, and the flat face is located above the first concave face.

12. The lens of claim 1, wherein the light incident face comprises a first depressed face concaved from a bottom face of the base.

13. The lens of claim 12, wherein the light incident face comprises a second depressed face and a third depressed face surrounded by the first depressed face.

14. The lens of claim 13, wherein the first depressed face, the second depressed face and the second depressed face are elliptical faces.

15. The lens of claim 14, wherein long axes of the first depressed face and the third depressed face extend along the second direction, and a long axis of the second depressed face extends along the first direction.

16. The lens of claim 13, wherein the light incident face comprises a fourth depressed face located between the second depressed face and the third depressed face, the fourth depressed face directly connecting the second depressed face and the third depressed face.

17. The lens of claim 16, wherein the light incident face comprises a protruding face formed on the fourth depressed face, the protruding face protruding in a direction away from the light emerging face.

18. The lens of claim 17, wherein the fourth depressed face and the protruding face are elliptical faces, long axes of the fourth depressed face and the protruding face extending along the second direction.

19. The lens of claim 16, wherein the lens comprises two ridges formed on the light incident face, each ridge directly connecting the first depressed face, the second depressed face, the third depressed face and the fourth depressed face.

20. The lens of claim 1, wherein the base comprises a first lateral face and a second lateral face opposite to the first lateral face, the light emerging face being located adjacent to the second lateral face more than the first lateral face.
